(19) United States
(12) Patent Application Publication
(10) Pub. No.: US 2026/0055796 A1
(43) Pub. Date: Feb. 26, 2026

(54) MOUNT FOR A VEHICLE

(71) Applicants: HYUNDAI MOTOR COMPANY, Seoul (KR); KIA CORPORATION, Seoul (KR)

(72) Inventors: Kwang Jin Choi, Hwaseong-si (KR); Hyo Seok Kim, Hwaseong-si (KR)

(73) Assignees: HYUNDAI MOTOR COMPANY, Seoul (KR); KIA CORPORATION, Seoul (KR)

(21) Appl. No.: 18/952,750

(22) Filed: Nov. 19, 2024

(30) Foreign Application Priority Data
Aug. 26, 2024 (KR) 10-2024-0113961

(51) Int. Cl. F16F 1/38; B60K 1/00

(52) U.S. Cl. CPC F16F 1/38; B60K 1/00

(57) ABSTRACT

Disclosed is a mount for a vehicle, wherein the mount includes: an outer pipe made of a plastic material and having a slit having one end and another end facing and spaced apart from each other in a circumferential direction of the outer pipe; an inner pipe coaxially arranged with, and disposed within, the outer pipe; a main rubber component coupled to the inner pipe and mounted on an inner circumferential surface of the outer pipe; and a bracket having formed therein a press-fit hole into which the outer pipe is configured to be press-fitted when the one end and the other end of the slit are joined to each other.

### CROSS-REFERENCE TO RELATED APPLICATION

This application claims, under 35 U.S.C. § 119 (a), the benefit of and priority to Korean Patent Application No. 10-2024-0113961, filed on Aug. 26, 2024, the entire contents of which are incorporated herein by reference.

### TECHNICAL FIELD

The present disclosure relates to a mount for a vehicle. More particularly, the present disclosure relates to a mount for a vehicle capable of reducing weight and cost and solving quality problems, such as corrosion, by using an outer pipe made of a plastic material.

### BACKGROUND

Generally, an electric vehicle is equipped with a power electronic (PE) module as a power source consisting of a motor and a reducer. A PE module has characteristics of not having an idle state that occurs in an internal combustion engine vehicle and of operating in a high-frequency band.

The PE module is mounted on a vehicle body using a tube mount in consideration of operating conditions in a high-frequency band, and is mounted on the vehicle body in a three-point or four-point mount method to control static and dynamic behavior.

A general PE module mount, i.e., PE mount, is manufactured in such a way that a main rubber component is vulcanized on an outer pipe and inner pipe made of steel, and then the outer pipe is swaged to be press-fitted into a bracket.

However, when the material of the outer pipe is switched to plastic in order to reduce the weight and cost of the PE mount, disadvantages caused by switching material may be overcome in terms of shape and structure and it may be advantageous in terms of quality issues, such as corrosion, as well as cost and weight because the design freedom for shape implementation is greater than that of a general outer pipe made of steel, but there is a problem of deteriorating durability performance.

In other words, in the case of manufacturing a PE mount using an outer pipe made of steel, the main rubber component is vulcanized on the outer pipe and inner pipe, and then the outer pipe is swaged to be press-fitted into the bracket, so that compressive residual stress may be applied to the main rubber component in advance, which is advantageous in terms of durability.

However, in the case of manufacturing a PE mount using an outer pipe made of plastic, the outer pipe is press-fitted into the bracket at a high temperature immediately after vulcanizing the main rubber component on the outer pipe and inner pipe, and swaging the outer pipe to a degree that compressive residual stress is pre-applied to the main rubber component would result in breakage prior to plastic deformation of the plastic outer pipe, and therefore cannot be applied.

Therefore, when a PE mount is manufactured using an outer pipe made of plastic, it is not possible to pre-compensate for excessive stress and strain caused by external loads because compressive residual stress through swaging cannot be pre-applied to the main rubber component, thereby deteriorating durability performance of the main rubber component.

The above information disclosed in this Background section is only for enhancement of understanding of the background of the present disclosure, and therefore it may contain information that does not form the prior art that is already known to a person of ordinary skill in the art.

### SUMMARY OF THE DISCLOSURE

The present disclosure has been made in an effort to solve the above-described problems associated with the prior art, and an object of the present disclosure is to provide a mount for a vehicle, wherein an outer pipe, which is a component of the mount and configured to interconnect an insulator and a bracket, is made of plastic and partially has an open structure, preventing damage such as bending or folding of the outer pipe during swaging, regardless of the material properties, and the outer pipe has a catch structure protruding at front and rear portions thereof, preventing axial separation when assembled in the bracket.

In one aspect, the present disclosure provides a mount for a vehicle, wherein the mount may include an outer pipe made of a plastic material and having formed therein a slit having one end and another end facing and spaced apart from each other in a circumferential direction of the outer pipe. The mount may further include an inner pipe coaxially arranged with, and disposed within, the outer pipe, and a main rubber component coupled to the inner pipe and mounted on an inner circumferential surface of the outer pipe. The mount may also include a bracket having formed therein a press-fit hole into which the outer pipe is configured to be press-fitted in a state in which the one end and the other end of the slit are joined to each other.

In an embodiment, the outer pipe may include a first catch protruding from one end portion of the outer pipe so as to be caught in the press-fit hole at a front side of the bracket, and a second catch protruding from another end portion of the outer pipe so as to be caught in the press-fit hole at a rear side of the bracket.

In another embodiment, the first catch and the second catch each may be formed upright and have a predetermined length in a vertical direction. A portion of the first catch may be inclined downward in a direction in which the outer pipe is pressed into the press-fit hole.

In still another embodiment, the outer pipe may include a first matching portion defined at the one end of the slit, and a second matching portion having a shape corresponding to that of the first matching portion and defined at the other end of the slit.

In yet another embodiment, the first matching portion may include a mounting groove, and the second matching portion may include a locking projection protruding therefrom and configured to be inserted into the mounting groove.

In still yet another embodiment, the first matching portion and the second matching portion may include toothed members, respectively, wherein the toothed members may have shapes corresponding to each other.

In a further embodiment, the first matching portion may include a first locking member formed in a stepped manner, and the second matching portion may include a second locking member formed and configured to be engaged with the first locking member.

Other aspects and embodiments of the present disclosure are discussed below.

It is to be understood that the term “vehicle” or “vehicular” or other similar terms as used herein are inclusive of motor vehicles in general, such as passenger automobiles including sport utility vehicles (SUVs), buses, trucks, various commercial vehicles, watercraft including a variety of boats and ships, aircraft, and the like, and include hybrid vehicles, electric vehicles, plug-in hybrid electric vehicles, hydrogen-powered vehicles, and other alternative fuel vehicles (e.g., fuels derived from resources other than petroleum). As referred to herein, a hybrid vehicle is a vehicle that has two or more sources of power, for example, a vehicle powered by both gasoline and electricity.

The above and other features of the present disclosure are discussed below.

### BRIEF DESCRIPTION OF THE DRAWINGS

The above and other features of the present disclosure are described in detail with reference to certain embodiments thereof illustrated in the accompanying drawings which are given herein below by way of illustration only, and thus are not limitative of the present disclosure, and wherein:

FIG. 1 is a view illustrating a mount for a vehicle according to an embodiment of the present disclosure;

FIG. 2 is a view illustrating an outer pipe for a mount for a vehicle according to an embodiment of the present disclosure;

FIG. 3 and FIG. 4 are views illustrating an initial state of an outer pipe for a mount for a vehicle according to an embodiment of the present disclosure;

FIG. 5 and FIG. 6 are views illustrating a press-fitted state of an outer pipe for a mount for a vehicle according to an embodiment of the present disclosure;

FIG. 7 is a view illustrating press-fitting of an outer pipe into a mount for a vehicle according to an embodiment of the present disclosure;

FIG. 8 is a view illustrating a first catch and a second catch for a mount for a vehicle according to an embodiment of the present disclosure; and

FIGS. 9A-9C are views each illustrating an embodiment of a first matching portion and a second matching portion for a mount for a vehicle according to embodiments of the present disclosure.

It should be understood that the appended drawings are not necessarily to scale, presenting a somewhat simplified representation of various features illustrative of the basic principles of the present disclosure. The specific design features of the present disclosure, including, for example, specific dimensions, orientations, locations, and shapes, will be determined in part by the particular intended application and usage environment.

In the figures, the reference numbers refer to the same or equivalent parts of the present disclosure throughout the several figures of the drawing.

### DETAILED DESCRIPTION

Hereinafter, embodiments according to the present disclosure are described in detail with reference to the accompanying drawings.

Advantages and features of the present disclosure, and a method of achieving the same, should be apparent with reference to the embodiments described below in detail in conjunction with the accompanying drawings.

However, the present disclosure may be embodied in many different forms, and should not be construed as being limited to the embodiments set forth herein. Rather, the embodiments are provided so that the present disclosure is thorough and complete, and fully conveys the scope of the present disclosure to those having ordinary skill in the art. The present disclosure is defined only by the categories of the claims.

In describing the present disclosure, if a detailed explanation of a related known function or construction is considered to unnecessarily obscure the gist of the present disclosure, such explanation has been omitted but would be understood by those having ordinary skill in the art.

When a component, device, element, or the like of the present disclosure is described as having a purpose or performing an operation, function, or the like, the component, device, or element should be considered herein as being “configured to” meet that purpose or to perform that operation or function.

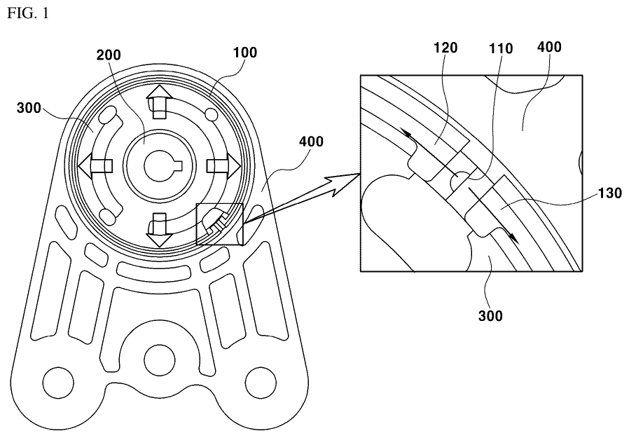

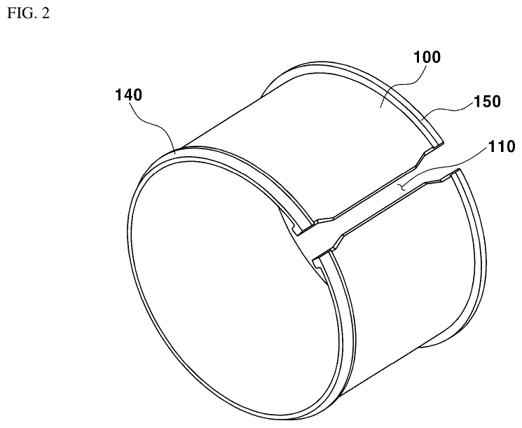

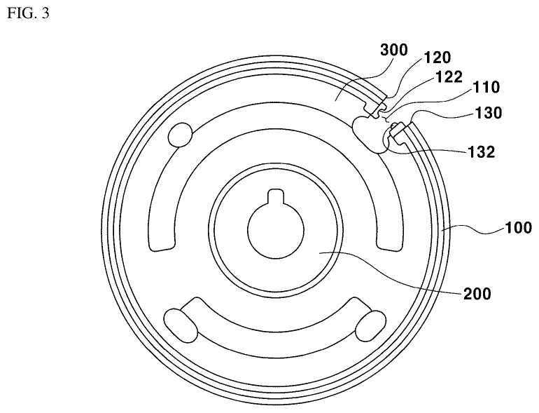

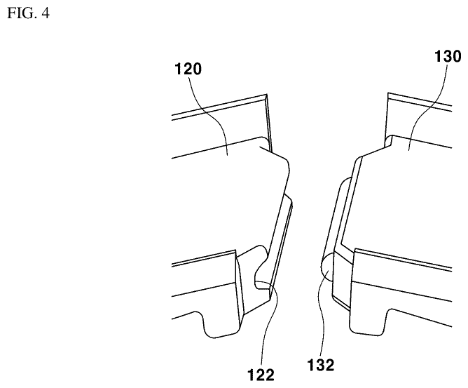

FIG. 1 is a view illustrating a mount for a vehicle according to an embodiment of the present disclosure. FIG. 2 is a view illustrating an outer pipe for a mount for a vehicle according to an embodiment of the present disclosure. FIG. 3 and FIG. 4 are views illustrating an initial state of an outer pipe for a mount for a vehicle according to an embodiment of the present disclosure.

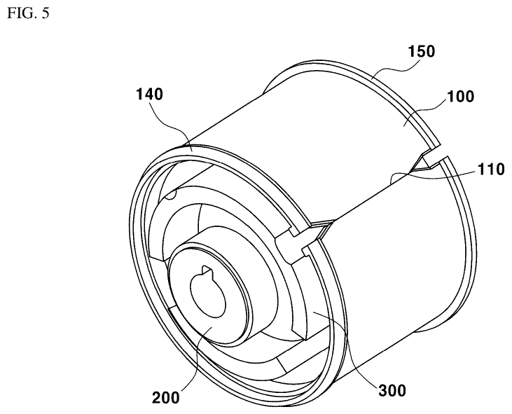

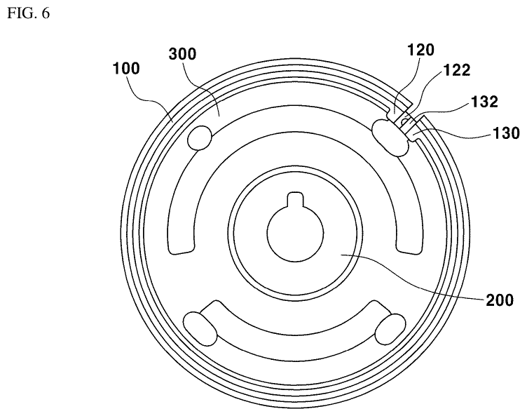

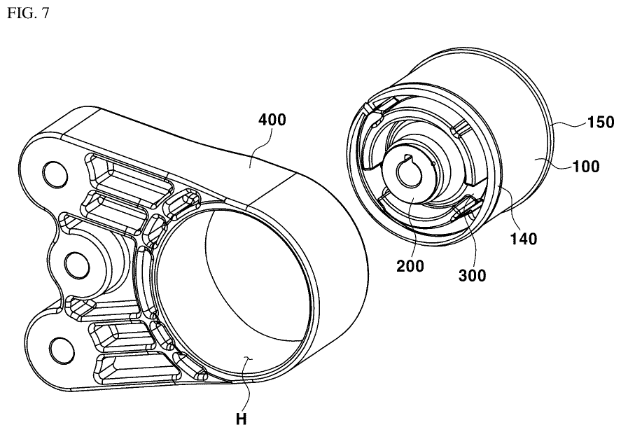

FIG. 5 and FIG. 6 are views illustrating a press-fitted state of an outer pipe for a mount for a vehicle according to an embodiment of the present disclosure. FIG. 7 is a view illustrating press-fitting of an outer pipe into a mount for a vehicle according to an embodiment of the present disclosure.

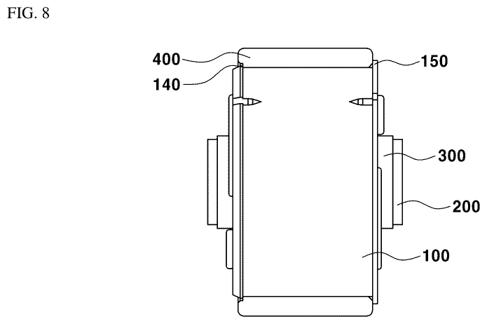

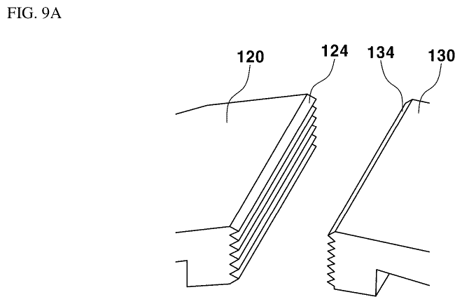

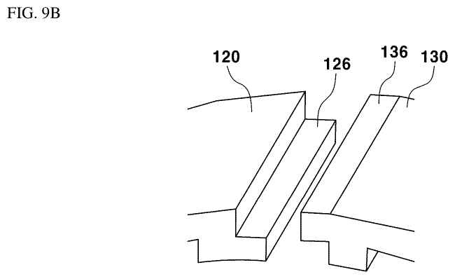

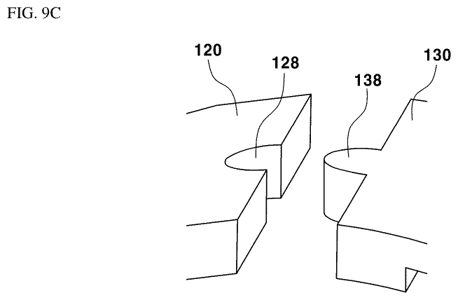

FIG. 8 is a view illustrating a first catch and a second catch for a mount for a vehicle according to an embodiment of the present disclosure. FIGS. 9A-9C are views each illustrating an embodiment of a first matching portion and a second matching portion for a mount for a vehicle according to embodiments of the present disclosure.

Generally, an electric vehicle is heavier than an internal combustion engine vehicle due to the heavy weight of dedicated components, such as a battery, and as the weight of the vehicle increases, energy efficiency decreases. For this reason, applying lightweight technology to the electric vehicle is a very important task in the future automobile market.

Recently, interest in material lightweighting has been greatly increasing due to limitations of conventional lightweighting technologies, such as structural lightweighting and simplification of construction methods, and degression of efficiency.

Differently put, although material lightweighting, which is a method of replacing a steel material with a lightweight material or partially fusing a lightweight material with steel, is more effective than lightweighting through structural or engineering improvements, material lightweighting needs changes in manufacturing methods and designs and has a disadvantage of deteriorating mechanical performance, such as rigidity.

For this reason, the present embodiments provide a mount for a vehicle including, as illustrated in FIG. 1, an outer pipe 100, an inner pipe 200, a main rubber component 300, and a bracket 400, wherein the outer pipe 100 is made of a plastic material instead of a steel material, which was conventionally used, to solve such problems.

In one example, the outer pipe 100 is made of a plastic material and has a cylindrical shape.

The inner pipe 200 may be made of a metal material, such as aluminum or steel, and have a cylindrical shape. The main rubber component 300 (or insulator) is provided on the outer circumferential surface of the inner pipe 200.

As the main rubber component 300 is assembled inside the outer pipe 100, the inner pipe 200 is arranged coaxially with the outer pipe 100 within the outer pipe 100.

The inner pipe 200 is connected to a power electric (PE) module or powertrain through a separate fastening member (not shown) and transmits the load of the PE module or powertrain to the main rubber component 300.

The main rubber component 300 is, by using the characteristics of a rubber material, configured to support the load of the component, i.e., the PE module or powertrain connected to the inner pipe 200 and insulate vibration. In this regard, the main rubber component 300 may also be referred to herein as an insulator or an insulator component.

The main rubber or insulator component 300 may be vulcanized on the outer circumferential surface of the inner pipe 200, and be assembled to the outer pipe 100 while placed on the outer circumferential surface of the inner pipe 200.

The outer pipe 100 has formed therein, as illustrated in FIG. 1 and FIG. 2, a slit 110 having one end (i.e., a first end) and another end (i.e., a second end) facing and spaced apart from each other in the circumferential direction of the outer pipe 100.

Generally, the outer pipe 100 is a structure to connect an insulator, including the inner pipe 200 and the main rubber component 300, to the bracket 400. To prevent the insulator from being separated from the bracket 400, the residual stress of the main rubber component 300 should be removed through a swaging process. However, because the outer pipe 100 is made of a plastic material, damage such as breakage or tearing may occur during the swaging process due to the material properties.

More specifically, because the main rubber component 300 is made of a rubber material, residual stress is produced due to shrinkage when the main rubber component 300 is cooled after injection, and the residual stress may create cracks and the like in the main rubber component 300.

For this reason, the outer pipe 100 has formed therein the slit 110 in the circumferential direction and, as illustrated in FIG. 5, the slit 110 is closed during swaging to allow the one end and the other end to selectively come into contact with each other, preventing bending or folding and the like using the mutually pushing force acting between the one end and the other end (see the directions of arrows in FIG. 1).

The slit 110 structure of the outer pipe 100 may prevent bending or folding of the outer pipe 100 and allow the outer pipe 100 to be press-fitted into the bracket 400 while removing the residual stress of the main rubber component 300, ensuring durability of the main rubber component 300.

The outer pipe 100 may include, as illustrated in FIG. 3, a first matching portion 120 and a second matching portion 130.

The first matching portion 120 is defined at the one end of the slit 110.

The second matching portion 130 has a shape corresponding to that of the first matching portion 120 and is defined at the other end of the slit 110.

As illustrated in FIG. 4, the first matching portion 120 may include a mounting groove 122, and the second matching portion 130 may include a locking projection 132 protruding toward the mounting groove 122.

The mounting groove 122 and the locking projection 132 may guide the first matching portion 120 and the second matching portion 130 to be aligned with each other when coming into contact with each other during swaging of the outer pipe 100, and may also prevent misalignment of the first matching portion 120 and the second matching portion 130 by fixing the outer pipe 100 in place when the outer pipe 100 is press-fitted into the bracket 400.

The outer pipe 100 may shrink or deform due to the material limitations of plastics, and also, when the main rubber component 300 is vulcanized, a contact surface between the inner circumferential surface of the outer pipe 100 and the main rubber component 300 may become uneven, so the insulator may not be securely fixed in a press-fit hole H (see FIG. 7) in the bracket 400.

For this reason, the first matching portion 120 and the second matching portion 130 facing each other with the slit 110 therebetween are provided with the mounting groove 122 and the locking projection 132, respectively, and the mounting groove 122 and the locking projection 132 are, as illustrated in FIG. 5 and FIG. 6, coupled to each other when the outer pipe 100 is swaged to be press-fitted into the press-fit hole H. Therefore, even when the outer pipe 100 shrinks or deforms, or the contact surface between the main rubber component 300 and the inner circumferential surface of the outer pipe 100 is uneven, the position of the matching surface between the first matching portion 120 and the second matching portion 130 may be effectively guided.

The structure of the mounting groove 122 and locking projection 132 allows the first matching portion 120 and the second matching portion 130 to be fixed in place while being matched to each other, preventing misalignment of the first matching portion 120 and the second matching portion 130.

The structure of the mounting groove 122 and locking projection 132 in FIGS. 1, 3, and 4 is only one embodiment, but the structure may have different shapes to achieve the same purpose.

In one embodiment, the first matching portion 120 and the second matching portion 130 may include, as illustrated in FIG. 9A, toothed members 124 and 134 having shapes corresponding to each other.

Accordingly, when the outer pipe 100 is swaged to be press-fitted into the press-fit hole H as illustrated in FIG. 5 and FIG. 6, the toothed members 124 and 134 are engaged with each other, guiding the first matching portion 120 and the second matching portion 130 to match each other and preventing vertical misalignment of the first matching portion 120 and the second matching portion 130.

In another embodiment, as illustrated in FIG. 9B, the first matching portion 120 may include a first locking member 126 formed in a stepped manner, and the second matching portion 130 may include a second locking member 136 formed to be engaged with the first locking member 126 (i.e., in an opposite stepped manner).

Accordingly, when the outer pipe 100 is swaged to be press-fitted into the press-fit hole H as illustrated in FIG. 5 and FIG. 6, the first locking member 126 and the second locking member 136 are coupled to be engaged with each other, guiding the first matching portion 120 and the second matching portion 130 to match each other and preventing vertical misalignment of the first matching portion 120 and the second matching portion 130.

In yet another embodiment, as illustrated in FIG. 9C, the first matching portion 120 may include an inlet hole 128 at a central portion thereof, and the second matching portion 130 may include a protrusion 138 formed to be inserted into the inlet hole 128.

Accordingly, when the outer pipe 100 is swaged to be press-fitted into the press-fit hole H as illustrated in FIG. 5 and FIG. 6, the inlet hole 128 and the protrusion 138 are engaged with each other by the protrusion 138 being inserted into the inlet hole 128, guiding the first matching portion 120 and the second matching portion 130 to match each other and preventing lateral misalignment of the first matching portion 120 and the second matching portion 130.

The shapes of the first matching portion 120 and second matching portion 130 to prevent misalignment thereof are not limited to these embodiments (see FIGS. 9A-9C), and may vary to achieve the same purpose.

The outer pipe 100 may include, as illustrated in FIG. 7, a first catch 140 and a second catch 150.

The first catch 140 protrudes from one end portion of the outer pipe 100 so as to be caught in the press-fit hole H at a front side of the bracket 400.

The second catch 150 protrudes from another end portion of the outer pipe 100 so as to be caught in the press-fit hole H at a rear side of the bracket 400.

The first catch 140 and the second catch 150 have a predetermined length in a vertical direction and are formed upright at a 90° angle (i.e., in relation to an outer surface of the outer pipe 100, such that each of the first catch 140 and the second catch 150 extend outward from the outer surface of the outer pipe 100), preventing forward and rearward movement of the outer pipe 100 when the outer pipe 100 is pressed into the press-fit hole H.

The first catch 140 and the second catch 150 may be different from each other in shape.

The first catch 140 (or a portion thereof) may be inclined downward in a direction in which the outer pipe 100 is pressed into the press-fit hole H, as illustrated in FIG. 8.

In other words, by a portion of the first catch 140 being inclined as described above, the outer pipe 100 may be easily inserted into the press-fit hole H in the pressing direction while sliding on the inclined surface, improving the assemblability of the outer pipe 100 to the bracket 400.

As a result, because the first catch 140 of the outer pipe 100 is formed upright at the one end portion of the outer pipe 100 including the inclined surface and the second catch 150 is formed upright at the other end portion of the outer pipe 100 while facing the first catch 140 and forming a 90° angle, the assemblability may be improved by the one end portion of the outer pipe 100 and the detaching force may be maximized by the other end portion of the outer pipe 100.

As is apparent from the above description, the present disclosure provides the following effects.

According to the present disclosure, the outer pipe for interconnecting the insulator and the bracket is made of a plastic material and partially has an open structure, preventing damage such as bending or folding of the outer pipe during swaging, regardless of the material properties. The outer pipe has a catch structure at front and rear portions thereof, preventing axial separation when assembled in the bracket.

By using plastic as a material for the outer pipe, instead of steel as used conventionally, weight and cost may be reduced compared to the case where a steel material is used, and quality problems such as corrosion may be solved.

Moreover, regarding the open structure of the outer pipe, the shape of the matching area is processed and formed to prevent misalignment, preventing problems such as the insulator getting loose and moving inside the bracket due to an insufficient fixing force.

In the above, embodiment(s) of the present disclosure have been described with reference to the accompanying drawings. However, those having ordinary skill in the art to which the present disclosure pertains will understand that various modifications may be made therefrom, and that all or part of the above-described embodiment(s) may be selectively combined. Therefore, the true technical protection scope of the present disclosure should be determined by the technical ideas of the appended claims.

What is claimed is:

1. A mount for a vehicle, the mount comprising:
an outer pipe made of a plastic material and having a slit having one end and another end facing and spaced apart from each other in a circumferential direction of the outer pipe;
an inner pipe coaxially arranged with, and disposed within, the outer pipe;
a main rubber component coupled to the inner pipe and mounted on an inner circumferential surface of the outer pipe; and
a bracket having formed therein a press-fit hole into which the outer pipe is configured to be press-fitted when the one end and the other end of the slit are joined to each other.

2. The mount of claim 1, wherein the outer pipe comprises:
a first catch protruding from one end portion of the outer pipe so as to be caught in the press-fit hole at a front side of the bracket; and
a second catch protruding from another end portion of the outer pipe so as to be caught in the press-fit hole at a rear side of the bracket.

3. The mount of claim 2, wherein the first catch and the second catch are each formed upright and have a predetermined length in a vertical direction.

4. The mount of claim 3, wherein a portion of the first catch is inclined downward in a direction in which the outer pipe is pressed into the press-fit hole.

5. The mount of claim 1, wherein the outer pipe comprises:
a first matching portion defined at the one end of the slit; and
a second matching portion having a shape corresponding to that of the first matching portion and defined at the other end of the slit.

6. The mount of claim 5, wherein:
the first matching portion includes a mounting groove; and
the second matching portion includes a locking projection protruding therefrom and configured to be inserted into the mounting groove.

7. The mount of claim 5, wherein the first matching portion and the second matching portion include toothed members, respectively, wherein the toothed members have shapes corresponding to each other.

8. The mount of claim 5, wherein:
the first matching portion includes a first locking member formed in a stepped manner; and
the second matching portion includes a second locking member formed and configured to be engaged with the first locking member.
